(19) United States
(12) Patent Application Publication
(10) Pub. No.: US 2024/0254686 A1
(43) Pub. Date: Aug. 1, 2024

(54) ANTIMICROBIAL SANITIZING DRYER COMPOSITIONS

(71) Applicant: The Clorox Company, Oakland, CA (US)

(72) Inventors: Timothy Mui, Pleasanton, CA (US); Katelyn Hammond, Saint Paul, MN (US); AC Carlton, Pleasanton, CA (US); Tiffney Kathir, Evanston, IL (US)

(21) Appl. No.: 18/399,180

(22) Filed: Dec. 28, 2023

Related U.S. Application Data
(60) Provisional application No. 63/481,912, filed on Jan. 27, 2023.

(51) Int. Cl. D06M 23/02; C11D 3/39; C11D 3/48; C11D 17/04

(52) U.S. Cl. CPC D06M 23/02; C11D 3/3942; C11D 3/48; C11D 17/041; C11D 2111/12

(57) ABSTRACT

Methods and systems for providing sanitization or disinfection of fabric articles within a dryer. A dryer sanitization or disinfection composition includes an antimicrobial active (e.g., included from 0.05% to 5% by weight of the antimicrobial active). The sanitization or disinfection composition is placed into the dryer with one or more fabric articles, in order to sanitize or disinfect such fabric articles. Fabric articles may be wet (from the washer), or already dry. In an embodiment, the antimicrobial active may be a peroxide (e.g., hydrogen peroxide). The composition may be free of cyclodextrins, water soluble polyionic polymers, pH adjusting mineral salts, zeolites, activated carbon, other deodorizer agents, biguanides, antimicrobial halogenated compounds, antimicrobial phenyl or phenolic compounds, antimicrobial metallic salts, or other classes of antimicrobial compounds (e.g., quats, organic acids included for antimicrobial effect, etc.)

### CROSS-REFERENCE TO RELATED APPLICATIONS

The present application claims the benefit of U.S. Provisional Patent Application Ser. No. 63/481,912, filed Jan. 27, 2023, entitled “ANTIMICROBIAL SANITIZING DRYER COMPOSITIONS” the disclosure of which is incorporated by reference in its entirety.

### BACKGROUND OF THE INVENTION

### 1. The Field of the Invention

The present invention relates to compositions for use in laundry sanitization, e.g., particularly for use within a dryer.

### 2. Description of Related Art

Various laundry treatments are available, e.g., typically for stain removal and the like. Many such treatment compositions are added to the wash water used to wash such fabrics, or are used in pre-treating such fabrics prior to washing within the wash water of a washing machine. While numerous treatment compositions are available, there exists a continuing need for additional options that would provide for sanitization of laundry, particularly by addition of a composition to the laundry within the dryer, rather than requiring addition within the washer. More particularly, there are few if any compositions available that provide an antimicrobial benefit within any laundry step—within the washer or the dryer. Applicant has recently filed applications directed to sanitization within the washer, e.g., as described in patent application Ser. No. 17/673,191 (222.294A/17074.167.1) filed Feb. 16, 2022 and patent application Ser. No. 17/716,605 (222.292A/17074.160.1) filed Apr. 8, 2022, each of which is herein incorporated by reference in its entirety. It would be a further benefit if a composition (or composition loaded into a wipe or similar article) were provided that could be added to a dryer, to provide an antimicrobial benefit (e.g., sanitization) of the fabric articles being laundered at that stage, rather than requiring addition to the washer.

### BRIEF SUMMARY

While it is possible to sanitize fabric articles within a dryer, such sanitization typically requires long treatment times (e.g., 90 minutes or more) and very high temperatures (e.g., 140° F.). The present disclosure describes compositions that can be used to provide sanitization (e.g., a 3 log reduction against a target microbe) within a dryer in shorter periods of time, at lower temperatures.

In an embodiment, the present invention is directed to a method for providing sanitization or disinfection of fabric articles within a dryer (i.e., a fabric article drying appliance). The term “dryer” may be used herein for convenience. The population at large will appreciate that “dryer” refers to such a household appliance (or as found in a laundromat), available in the vast majority of homes within the United States, as well as in many other countries throughout the world. Such methods may include providing a dryer sanitization or disinfection composition that includes an antimicrobial active. For example, such composition may include from 0.05% to 5% by weight of the antimicrobial active. The method further includes introducing the sanitization or disinfection composition into the dryer with one or more fabric articles, in order to sanitize or disinfect such fabric articles. Such introduction may occur at the same time as the dryer is providing drying of such fabric articles. In an embodiment, already dry fabric articles could be placed in the dryer and run through the dryer cycle with the sanitization or disinfection composition, even if no drying of the fabric articles is to be achieved. The sanitization or disinfection composition may be loaded onto a wipe or similar substrate (e.g., and simply added to the dryer, with the load of fabric articles being treated). Various other methods are also possible, such as spraying a given dose (e.g., 10-200 g, or 20-100 g) onto the fabric articles being treated before starting the drying cycle, introduction of the composition into a dispensing mechanism provided within the dryer, or even placement of a dosed substrate (e.g., wipe) over the air inlet vent which delivers heated air to the drum of the dryer, so that the composition is entrained into the heated air being delivered to the dryer drum, during the drying cycle. It will be appreciated that additional delivery methods may also be possible.

In an embodiment, the composition may be free or substantially free of cyclodextrins, water soluble polyionic polymers, pH adjusting mineral salts, zeolites, activated carbon, or other deodorizer agents such as those described in US 2009/0193593, herein incorporated by reference in its entirety. Furthermore, in an embodiment, the present compositions may be free or substantially free of biguanides or similar alternative antimicrobial halogenated compounds, phenyl or phenolic compounds, or metallic salts (e.g., copper, zinc or silver antimicrobial salts). In an embodiment, the employed antimicrobial active may be a peroxide, such as hydrogen peroxide. In such embodiments, the composition may be free or substantially free of other classes of antimicrobial compounds, including but not limited to quaternary amines (“quats”), organic acids or salts thereof, included as antimicrobial actives. A small amount of such organic acids (e.g., citric acid) may still be present simply for pH adjustment, buffering, or another purpose, other than antimicrobial activity. In an embodiment the composition may be free or substantially free of lower alcohols (e.g., ethanol, propanol, isopropanol, etc.).

In an embodiment, the dryer provides heat to the fabric articles and the sanitization or disinfection composition, e.g., providing a temperature of from 110° F. to 130° F., such as about 120° F. In an embodiment, the temperature provided in the dryer may be less than 150° F., less than 145° F., or less than 140° F.

In an embodiment, the dryer may provide heat to the fabric articles and the sanitization or disinfection composition, at a temperature as noted above (e.g., about 120° F.) for a period of time of at least 10 minutes, at least 15 minutes, at least 20 minutes, or at least 30 minutes. Treatment time may be less than 60 minutes, less than 50 minutes, or less than 40 minutes.

In an embodiment, the composition and temperature are sufficient to provide at least about a 3 log reduction against a desired gram negative or gram positive bacterial population within about 15 to about 30 minutes.

In an embodiment, the antimicrobial active comprises at least one of a peroxide (e.g., hydrogen peroxide), a quat (a quaternary amine compound), an inorganic acid, or a hypohalite (e.g., sodium hypochlorite). In an embodiment, the antimicrobial active consists of a peroxide (e.g., any other antimicrobial actives may be excluded).

In an embodiment, the antimicrobial active (e.g., a peroxide, such as hydrogen peroxide) is present in an amount of from 0.5% to 4%, or from 1% to 3% by weight.

In an embodiment, the composition is a liquid, e.g., rather than a solid, a thickened gel, etc. The composition may comprise a majority of water (e.g., at least 70%, at least 80%, at least 90%, at least 92% water). Such water may be present as free, unbound water.

Such a composition may be dosed onto a wipe or other substrate during manufacture. The composition may be provided to the dryer interior (the dryer drum) within any of a wide variety of configurations. For example, it can be dosed onto a wipe, pad, or similar substrate. It could be provided on or within a pod, which pod it tossed into the dryer with the fabric articles to be sanitized or disinfected. It could be dosed directly onto the fabric articles to be treated, or it could be introduced into the heated air stream being delivered to the dryer drum, for drying fabric articles. Other possible mechanisms for providing the composition to the dryer will also be apparent to those of skill in the art.

Another embodiment of the present methods may include providing a dryer sanitization or disinfection composition comprising from 0.05% to 5% by weight of an antimicrobial active that may be dosed onto a wipe or other substrate (e.g., even the fabric articles being sanitized or disinfected themselves), and placing the wipe or other substrate dosed with the sanitization or disinfection composition into the dryer with one or more fabric articles in order to sanitize or disinfect such fabric articles. The composition provides at least a 3 log reduction against at least one gram negative or gram positive bacterial population on the one or more fabric articles when cycled through the dryer for 20-40 minutes (e.g., 30 minutes) at a temperature of about 120° F.

In an embodiment, the antimicrobial active may comprise hydrogen peroxide.

In an embodiment, the antimicrobial active is present in an amount of from 0.5% to 4%, or from 1% to 3% by weight.

Another embodiment is directed systems for dispensing, which include the sanitizing or disinfecting composition itself, for use in providing sanitization or disinfection within a dryer. Such a composition may include 0.05% to 5% by weight of an antimicrobial active, where the composition provides at least a 3 log reduction against at least one gram negative or gram positive bacterial population within 30 minutes, when added to a dryer with fabric articles to be cycled through the dryer.

In an embodiment, the antimicrobial active may comprise hydrogen peroxide.

In an embodiment, the antimicrobial active is present in an amount of from 0.5% to 4%, or from 1% to 3% by weight.

In an embodiment, the composition may be dosed onto a wipe or other substrate during manufacture, or by the user (e.g., immediately before placing such within the dryer), or may be provided as a part of a system including a pod or other container within which the composition is held, where such pod or other container is added to the dryer drum when running fabric articles through a dryer cycle of the dryer.

Load size may vary widely, e.g., including a load as small as a single article of clothing or other fabric article, and may typically range from at least 1 lb, at least 2 lbs, or at least 3 lbs, up to 8 lbs, such as from 3 lbs to 6 lbs.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description of the invention will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings.

FIG. 1 shows initial antimicrobial efficacy results against Klebsiella aerogenes and Staphylococcus epidermidis, on different fabric types.

FIG. 2 shows initial antimicrobial efficacy results for citric acid and quat antimicrobial actives, on a cotton polyester blend.

FIG. 3 shows initial antimicrobial efficacy results for peroxide and citric acid antimicrobial actives, for different treatment times.

FIG. 4 shows initial antimicrobial efficacy results for peroxide compositions, at different temperatures, and on different substrates, compared to use of water alone.

FIG. 5 shows initial antimicrobial efficacy results for peroxide and quat antimicrobial actives, at different loading ratios, on different substrates.

FIG. 6 shows initial antimicrobial efficacy results for peroxide and citric acid antimicrobial actives, with different dryer load sizes, against Klebsiella aerogenes and Staphylococcus epidermidis.

FIG. 7 shows initial antimicrobial efficacy results for peroxide compositions as compared to commercially available dryer sheets.

FIG. 8 shows initial antimicrobial efficacy results for citric acid-based compositions on different substrates and with different fabrics, as compared to a peroxide-based composition.

FIG. 9 shows initial antimicrobial efficacy results for peroxide and citric acid-based compositions, where such are delivered in vapor form.

FIG. 10 shows initial antimicrobial efficacy results for citric acid-based compositions at different loading ratios dosed directly, or dosed on different substrates, as compared to a peroxide-based composition at the same loading ratios, loaded on the same substrates.

FIG. 11 shows initial antimicrobial efficacy results for peroxide compositions at different concentrations.

FIG. 12 shows initial antimicrobial efficacy results for peroxide compositions at different loading ratios and different contact times.

FIG. 13 shows initial antimicrobial efficacy results for peroxide compositions at different loading ratios against both Klebsiella aerogenes and Staphylococcus epidermidis.

FIG. 14 shows initial antimicrobial efficacy results for peroxide and citric-acid based compositions at different loading ratios against both Klebsiella aerogenes and Staphylococcus epidermidis.

FIG. 15 shows antimicrobial efficacy results for commercially available dryer sheets.

FIG. 16 shows initial antimicrobial efficacy results for various peroxide citric-acid, quat, and hypohalite compositions.

FIG. 17 shows initial antimicrobial efficacy results for peroxide and citric-acid based compositions against both Klebsiella aerogenes and Staphylococcus epidermidis, with a 3 lb wet load of fabric articles.

FIG. 18 shows initial antimicrobial efficacy results for peroxide and citric-acid based compositions against Klebsiella aerogenes on different fabrics.

FIG. 19 shows initial antimicrobial efficacy results for ultra-concentrated citric-acid based compositions on different substrates, at different loading ratios, against Klebsiella aerogenes.

FIG. 20 shows initial antimicrobial efficacy results for an exemplary peroxide composition as compared to various commercially available products, for contact times of 15 minutes, and 30 minutes.

FIG. 21 shows additional antimicrobial efficacy results for peroxide and citric acid-based compositions.

FIG. 22 shows additional antimicrobial efficacy results for exemplary peroxide compositions at temperatures of 70° F. and 120° F.

FIG. 23 shows additional antimicrobial efficacy results for exemplary peroxide compositions at contact times of 10 minutes and 15 minutes.

FIG. 24 shows additional antimicrobial efficacy results for exemplary peroxide compositions for 6 lb and 31b loads.

FIG. 25 shows additional antimicrobial efficacy results for exemplary peroxide compositions for different fabric types.

FIG. 26 shows additional antimicrobial efficacy results for exemplary citric acid-based compositions for different fabric types.

FIG. 27 shows additional antimicrobial efficacy results for exemplary peroxide compositions delivered using different substrates at different loading ratios, and delivered under alternative mechanisms.

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

The term “comprising” which is synonymous with “including,” “containing,” or “characterized by,” is inclusive or open-ended and does not exclude additional, unrecited elements or method steps.

The term “consisting essentially of” limits the scope of a claim to the specified materials or steps “and those that do not materially affect the basic and novel characteristic(s)” of the claimed invention.

The term “consisting of” as used herein, excludes any element, step, or ingredient not specified in the claim.

It must be noted that, as used in this specification and the appended claims, the singular forms “a,” “an” and “the” include plural referents unless the content clearly dictates otherwise. Thus, for example, reference to a “surfactant” includes one, two or more surfactants.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. As such, all values herein are understood to be modified by the term “about”. Such values thus include an amount or state close to the stated amount or state that still performs a desired function or achieves a desired result. A stated value should therefore be interpreted broadly enough to encompass values that are at least close enough to the stated value to perform a desired function or achieve a desired result, and/or values that round to the stated value. The stated values include at least the variation to be expected in a typical manufacturing or other process, and may include values that are within 10%, within 5%, within 1%, etc. of a stated value.

Some ranges may be disclosed herein. Additional ranges may be defined between any values disclosed herein as being exemplary of a particular parameter. All such ranges are contemplated and within the scope of the present disclosure.

As used herein, the term “between” is inclusive of any endpoints noted relative to a described range.

In the application, effective amounts are generally those amounts listed as the ranges or levels of ingredients in the descriptions, which follow hereto. Unless otherwise stated, amounts listed in percentage (“%'s”) are in weight percent (based on 100% active) of any composition.

The phrase ‘free of’ or similar phrases if used herein means that the composition or article comprises 0% of the stated component, that is, the component has not been intentionally added. However, it will be appreciated that such components may incidentally form thereafter, under some circumstances, or such component may be incidentally present, e.g., as an incidental contaminant.

The phrase ‘substantially free of’ or similar phrases as used herein means that the composition or article preferably comprises 0% of the stated component, although it will be appreciated that very small concentrations may possibly be present, e.g., through incidental formation, contamination, or even by intentional addition. Such components may be present, if at all, in amounts of less than 1%, less than 0.5%, less than 0.25%, less than 0.1%, less than 0.05%, less than 0.01%, less than 0.005%, less than 0.001%, or less than 0.0001%. In some embodiments, the compositions or articles described herein may be free or substantially free from any specific components not mentioned within this specification.

As used herein, “disposable” is used in its ordinary sense to mean an article that is disposed or discarded after a limited number of usage events, preferably less than 25, more preferably less than about 10, and most preferably after a single usage event. In an embodiment, substrates contemplated for use herein, whereon the dryer sanitization or disinfection composition is dosed are disposable.

As used herein, the term “substrate” is intended to include any material on which the dryer sanitization or disinfection composition is dosed, or otherwise stored or provided. Examples of substrates include, but are not limited to, wipes, pads, or a sheet of material on which the composition may be dosed. Such substrates may also potentially include pods or similar devices from which the composition is dispensed, during the dryer cycle. In an embodiment, the substrate may be in the form of a wipe, tossed into the dryer with the load of fabric articles to be sanitized and/or disinfected.

Some such substrates may be formed of a structure of individual fibers which are interlaid, typically in a manner that is not identifiable (e.g., a nonwoven). The nonwoven substrates, or layers used to make up such a nonwoven substrate included in the present substrates may be formed by any suitable process. For example, they may be meltblown, spunbond, spunlaid, SMS (spunbond-meltblown-spunbond), coformed, carded webs, thermal bonded, thermoformed, spunlace, hydroentangled, hydroembossed, needled, or chemically bonded. Various processes for forming such nonwovens will be apparent to those of skill in the art, many of which are described in U.S. Pat. No. 7,696,109, incorporated herein by reference in its entirety. EP Applications EP992338, EP1687136, EP1861529, EP1303661, and US2004/0157524 are also herein incorporated by reference, each in its entirety. These references describe various nonwoven structures which are generally illustrative, and which may be modified by using the contemplated plant-based renewable biodegradable and/or compostable fibers described herein rather than the synthetics typically employed in the prior art. Where the employed fibers are not thermoplastic (e.g., various pulp or cellulose derivatives), the processes used to form the nonwoven may of course not rely on melt-softening or thermoplasticity. Spunlace and hydroentangling are non-limiting examples of such processes.

The terms “wipe”, “substrate” and the like may thus overlap in meaning, and while “wipe” may typically be used herein for convenience, it will be appreciated that this term may often be interchangeable with “substrate”.

The compositions dosed onto the substrate as described herein may provide sanitization, disinfection, or sterilization, other cleaning, or other treatment. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24 hour time period is deemed “significant.” Greater levels of reduction (e.g., 99.9%, 99.99%, etc.) are possible, as are faster treatment times (e.g., within 10 minutes, within 5 minutes, within 4 minutes, within 3 minutes, within 2 minutes, within 1 minute, or within 30 seconds), when sanitizing or disinfecting.

As used herein, the term “disinfect” shall mean the elimination of many or all “target” pathogenic microorganisms on surfaces with the exception of bacterial endospores.

As used herein, the term “sterilize” shall mean the complete elimination or destruction of all forms of “target” microbial life and which is authorized under the applicable regulatory laws to make legal claims as a “sterilant” or to have sterilizing properties or qualities.

Some embodiments may provide for at least a 2 or more log reduction (e.g., 3-log reduction, 4-log reduction, 5-log reduction, or 6-log reduction) in a bacterial population within a designated time period (e.g., 30 minutes, 20 minutes, 15 minutes, 10 minutes, 5 minutes, or the like). A 2-log reduction is equivalent to a 99% reduction, a 3-log reduction is equivalent to at least a 99.9% reduction, a 4-log reduction is equivalent to at least a 99.99% reduction, a 5-log reduction is equivalent to at least a 99.999% reduction, etc. An example of a target microbe may be Staphylococcus epidermidis or Staphylococcus aureus. It will be appreciated that antimicrobial efficacy can also be achieved against other target microbes, numerous examples of which will be apparent to those of skill in the art.

In reference to various standardized tests (e.g., ASTM E2406, E2274 or other tests), it will be understood that reference to any such standard refers to the latest update (if any) to such standard, unless otherwise indicated. Any such referenced standards are incorporated herein by reference, in their entirety.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

In an embodiment, the present invention is directed to a method for providing sanitization or disinfection of fabric articles within a dryer (i.e., a fabric article drying appliance). The term “dryer” may be used herein for convenience. Such methods may include providing a dryer sanitization or disinfection composition that includes an antimicrobial active. In an embodiment, the composition may include from 0.05% to 5% by weight of the antimicrobial active. The method further includes placing the sanitization or disinfection composition into the dryer with one or more fabric articles, in order to sanitize or disinfect such fabric articles. Such may occur at the same time as the dryer is providing drying of such fabric articles. In another embodiment, the fabric articles may actually already be dry, or substantially dry (i.e., they were not just removed from the washing machine after the spin cycle). Data as provided herein shows that the degree of sanitization or disinfection can be greater, for a substantially dry load, than for a load where the fabric articles are loaded into the dryer in a “wet” condition (e.g., as routinely occurs when removing such articles from the washing machine, and placing them in the dryer, for drying). In other words, already dry fabric articles could be placed in the dryer and run through the dryer cycle with the sanitization or disinfection composition, even if no further drying of the fabric articles is desired to be achieved.

In contrast to the disclosure of US 2009/0193593, in an embodiment, the composition may be free or substantially free of cyclodextrins, water soluble polyionic polymers, pH adjusting mineral salts, zeolites, activated carbon, or other deodorizer agents. Furthermore, in an embodiment, the present compositions may be free or substantially free of one or more of (i) biguanides or similar antimicrobial halogenated compounds, (ii) phenyl or phenolic compounds, or (iii) metallic antimicrobial salts (e.g., copper, zinc or silver salts). In an embodiment, the employed antimicrobial active may be a peroxide, such as hydrogen peroxide. Data included in the present application shows that peroxide is typically more effective than such alternative antimicrobial compounds. In an embodiment, the composition may be free or substantially free of quats, organic acids or salts thereof, included as antimicrobial actives, for similar reasons (such materials are shown herein to be less effective than peroxide). It will be appreciated that a small amount of an organic acid or other such above listed materials may be present simply for pH adjustment, buffering, or another purpose, other than antimicrobial activity. In an embodiment the composition may be free or substantially free of lower alcohols (e.g., ethanol, propanol, isopropanol, etc.), as such materials present safety challenges during manufacturing, and result in undesirable VOC emissions.

### III. Sanitizing or Disinfecting Compositions

### A. Antimicrobial Active

A variety of antimicrobial actives known within the art may be suitable for use in the present sanitizing or disinfecting compositions for use with heat from a dryer to provide sanitization or disinfection of fabric articles (e.g., clothing, linens, towels, bedding, and other fabric articles). While quaternary ammonium compounds and organic acids (e.g., citric acid) can provide some level of sanitization or disinfection, the present inventors have found that a peroxide (e.g., hydrogen peroxide) provides particularly good results. Thus, in an embodiment, the antimicrobial active comprises a peroxide. In an embodiment, the formulation may actually be free, or substantially free of other antimicrobial actives, such as organic acids (e.g., citric acid), quats, hypohalites, or the like.

The formulation can be dosed onto a wipe, or otherwise provided on a substrate, in a “pod”, or other substrate that can be added to a dryer, with fabric articles to be sanitized. In an embodiment, such fabric articles may already be substantially dry (they are not being loaded into the dryer for drying). By way of example, in an embodiment, the composition is an aqueous composition, including at least 70%, at least 80%, at least 90%, at least 92%, at least 93%, at least 94%, or at least 95% water by weight. The composition may include a peroxide as an antimicrobial active. For example, the peroxide (e.g., hydrogen peroxide) may be included from 0.05%, from 0.1%, from 0.2%, from 0.3%, from 0.5%, from 1%, up to 5%, up to 4%, or up to 3% (e.g., 1-3%) by weight of the composition. Other antimicrobial actives could be provided within the same ranges. Relatively higher concentrations of the antimicrobial active may dictate that relatively less of the composition be added to the dryer load, to achieve the desired sanitization (e.g., fewer dosed substrates added to the load, such as 1 to 3 (e.g., 1 or 2 or 3 sheets)). Relatively lower concentrations may require higher amounts.

In an embodiment, the peroxide is the only included antimicrobial active. For example, no quats or organic acids may be present in sufficiently high amounts to serve as an antimicrobial active. While some organic acids can provide some antimicrobial efficacy, applicant has found that such compositions are typically not as effective as peroxide-based compositions used in the context (dryer sanitization) as described herein.

Examples of such organic acids that may be excluded as antimicrobial actives, include but are not limited to, citric acid, lactic acid, glycolic acid, and other carboxylic acids. While such acids may not be used as antimicrobial actives in the present embodiments, one or more of such acids may be present in a small amount, for another purpose, such as a buffer or pH adjuster (e.g., in an amount of less than 0.3%, less than 0.2%, or less than 0.1% by weight of the composition).

### B. Solvents

In an embodiment, the composition may be free of solvents other than water. If included, other solvents may be present in a small amount, or be absent, or substantially absent, as noted above. Examples of such solvents include but are not limited to glycol ether solvents such as ethylene glycol monopropyl ether, ethylene glycol monobutyl ether, ethylene glycol monohexyl ether, ethylene glycol phenyl ether, propylene glycol n-propyl ether, propylene glycol monobutyl ether, propylene glycol t-butyl ether, diethylene glycol monoethyl or monopropyl or monobutyl ether, di- or tri-polypropylene glycol methyl or ethyl or propyl or butyl ether, acetate and/or propionate esters of glycol ethers. Glycol and other solvents could alternatively be used. While some embodiments may include lower alcohol solvents (e.g., C₁-C₄ alcohols), the amount of such volatile solvents may be limited, e.g., to less than 10%, less than 5%, less than 3%, less than 2%, less than 1%, less than 0.5%, less than 0.4%, or less than 0.3% by weight. In some embodiments, the composition may be free of, or substantially free of, such lower alcohol or other highly volatile solvents. If a solvent other than water is present, such may be included from 0.1%, from 0.25%, up to 5%, up to 4%, up to 3%, up to 2%, or up to 1% by weight of the composition.

### C. Surfactants

Those of skill in the art will appreciate that any among a wide variety of surfactants (e.g., anionic, cationic, nonionic, zwitterionic, and/or amphoteric) may be included in the composition, as desired. Where included, a surfactant may be present from 0.05%, from 0.1%, up to 10%, up to 5%, up to 4%, up to 3%, up to 2%, or up to 1% by weight of the composition. Various surfactants and other optional adjuvants are disclosed in U.S. Pat. No. 3,929,678 to Laughlin and Heuring, U.S. Pat. No. 4,259,217 to Murphy, U.S. Pat. No. 5,776,872 to Giret et al.; U.S. Pat. No. 5,883,059 to Furman et al.; U.S. Pat. No. 5,883,062 to Addison et al.; U.S. Pat. No. 5,906,973 to Ouzounis et al.; U.S. Pat. No. 4,565,647 to Llenado, and U.S. Publication No. 2013/0028990. The above patents and applications are each herein incorporated by reference in their entirety.

Examples of nonionic surfactants include, but are not limited to, alcohol ethoxylates (e.g., secondary alcohol ethoxylates), alcohol propoxylates, other alcohol alkoxylates including fatty (e.g., C₆, C₈, C₁₀, or C₁₂, or higher) alcohols or other constituents that have been alkoxylated to include both ethoxy and propoxy groups (EO-PO surfactants), alkyl phosphine oxides, alkyl glucosides and alkyl pentosides, alkyl glycerol esters, alkyl ethoxylates, and alkyl and alkyl phenol ethoxylates of all types, poly alkoxylated (e.g. ethoxylated or propoxylated) C₆-C₁₂ linear or branched alkyl phenols, C₆-C₂₂ linear or branched aliphatic primary or secondary alcohols, and C₂-C₈ linear or branched aliphatic glycols. Block or random copolymers of C₂-C₆ linear or branched alkylene oxides may also be suitable nonionic surfactants. Capped nonionic surfactants in which the terminal hydroxyl group is replaced by halide; C₁-C₈ linear, branched or cyclic aliphatic ether; C₁-C₈ linear, branched or cyclic aliphatic ester; phenyl, benzyl or C₁-C₄ alkyl aryl ether; or phenyl, benzyl or C₁-C₄ alkyl aryl ester may also be used. Sorbitan esters and ethoxylated sorbitan esters may also be useful nonionic surfactants. Other suitable nonionic surfactants may include mono or polyalkoxylated amides of the formula R¹CONR²R³ and amines of the formula R¹NR²R³ wherein R¹ is a C₅-C₃₁ linear or branched alkyl group and R² and R³ are C₁-C₄ alkyl, C₁-C₄ hydroxyalkyl, or alkoxylated with 1-3 moles of linear or branched alkylene oxides. Biosoft 91-6 (Stepan Co.) is an example of an alkyl ethoxylate (or alcohol ethoxylate) having a methylene chain length of C₉ to C₁₁ with an average of 6 moles of ethoxylation. An example of an alcohol ethoxylate is ECOSURF EH-9, which is more specifically an ethylene oxide-propylene oxide copolymer mono(2-ethylhexyl) ether, available from Sigma-Aldrich.

Alkylpolysaccharide nonionic surfactants are disclosed in U.S. Pat. No. 4,565,647 to Llenado, having a linear or branched alkyl, alkylphenyl, hydroxyalkyl, or hydroxyalkylphenyl group containing from 6 to 30 carbon atoms and a polysaccharide, e.g., a polyglycoside, hydrophilic group containing from 1.3 to 10 saccharide units. Suitable saccharides may include, but are not limited to, glucosides, galactosides, lactosides, and fructosides. Alkylpolyglycosides may have the formula: R₂O(CnH₂ₙO)ₜ(glycosyl)ₓ wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 10.

Fatty acid saccharide esters and alkoxylated fatty acid saccharide esters may also be suitable for use in the present invention. Examples include, but are not limited to, sucrose esters, such as sucrose cocoate, and sorbitan esters, such as polyoxyethylene(20) sorbitan monooleate and polyoxyethylene(20) sorbitan monolaurate.

Phosphate ester surfactants may also be suitable. These include mono, di, and tri esters of phosphoric acid with C₄-C₁₈ alkyl, aryl, alkylaryl, alkyl ether, aryl ether and alkylaryl ether alcohols (e.g. disodium octyl phosphate).

Zwitterionic surfactants may be suitable. As zwitterionic surfactants include both a positive and negative functional group, they may also be classified as nonionic surfactants. Many such zwitterionic surfactants contain nitrogen. Examples of such include amine oxides, sarcosinates, taurates and betaines. Examples include C₈-C₁₈ alkyldimethyl amine oxides (e.g., octyldimethylamine oxide, lauryldimethylamine oxide (also known as lauramine oxide), and cetyldimethylamine oxide), C₄-C₁₆ dialkylmethylamine oxides (e.g. didecylmethylamine oxide), C₈-C₁₈ alkyl morpholine oxide (e.g. laurylmorpholine oxide), tetra-alkyl diamine dioxides (e.g. tetramethyl hexanane diamine dioxide, lauryl trimethyl propane diamine dioxide), C₈-C₁₈ alkyl betaines (e.g. decylbetaine and cetylbetaine), C₈-C₁₈ acyl sarcosinates (e.g. sodium lauroylsarcosinate), C₈-C₁₈ acyl C₁-C₆ alkyl taurates (e.g. sodium cocoylmethyltaurate), C₈-C₁₈ alkyliminodipropionates (e.g. sodium lauryliminodipropionate), and combinations thereof. Lauryl dimethyl amine oxide (Ammonyx LO) myristyl dimethyl amine oxide (Ammonyx MO), decylamine oxide (Ammonyx DO) are examples of suitable zwitterionic surfactants, available from Stepan Co.

Non-limiting examples of anionic surfactants include alkyl sulfates (e.g., C₈-C₁₈ linear or branched alkyl sulfates such as sodium lauryl sulfate (SLS), and sodium tetradecylsulfate), alkyl sulfonates (e.g., C₆-C₁₈ linear or branched alkyl sulfonates such as sodium octane sulfonate) and secondary alkane sulfonates, alkyl ethoxysulfates, fatty acids and fatty acid salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like.

More specific examples of nonionic and/or zwitterionic surfactants include lauryl dimethyl amine oxide (Ammonyx LO), also known as lauramine oxide, myristyl dimethyl amine oxide (Ammonyx MO), decylamine oxide (Ammonyx DO), other amine oxides, any betaines, linear alcohol ethoxylates, secondary alcohol ethoxylates, alcohol propoxylates, alkyl polyglucosides, and combinations thereof. In an embodiment, both an anionic and nonionic surfactant may be present.

### D. Additional Adjuvants

The composition may optionally include and/or be used in combination with one or more additional adjuncts. The adjuncts include, but are not limited to, fragrances or perfumes, waxes, dyes and/or colorants, solubilizing materials, stabilizers, thickeners, defoamers, hydrotropes, buffers, builders, lotions and/or mineral oils, enzymes, cloud point modifiers, and/or preservatives. Exemplary builders include, but are not limited to, phosphate-silicate compounds, zeolites, alkali metal, ammonium and substituted ammonium polyacetates, mono-, di-, and tri-alkali salts of nitrilotriacetic acid, carboxylates, aluminosilicate materials, silicates, polycarboxylates, zeolites, carbonates, phosphates, bicarbonates, polyphosphates, amines, alkanolamines, aminopolycarboxylates, polyhydroxysulfonates, starch derivatives, ethylenediamine tetraacetate, and/or metal ion sequestrants (e.g., aminopolyphosphonates such as, but not limited to, ethylenediamine tetramethylene phosphonic acid and diethylene triamine pentamethylenephosphonic acid).

In one embodiment, a builder detergent includes polyacetate and/or polycarboxylate compounds. In one aspect of this embodiment, the polyacetate and/or polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid.

In one embodiment, buffering and pH adjusting agents, when used, include, but are not limited to, organic acids (e.g., citric acid), mineral acids, alkali metal and alkaline earth salts of citrate, silicate, metasilicate, polysilicate, borate, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and/or 2-amino-2methylpropanol.

A buffering agent can be an active detergent in its own right, and/or can be a low molecular weight, organic or inorganic material used for maintaining the desired pH. The buffer can be alkaline, acidic or neutral. Non-limiting examples of buffering agents include nitrogen-containing materials (e.g., lysine; lower alcohol amines like mono-, di-, and tri-ethanolamine; tri(hydroxymethyl) amino methane; 2-amino-2-ethyl-1,3-propanediol; 2-amino-2-methyl-propanol; 2-amino-2-methyl-1,3-propanol; disodium glutamate; methyl diethanolamide; 2-dimethylamino-2-methylpropanol; 1,3-bis(methylamine)-cyclohexane; 1,3-diamino-propanol N,N′-tetra-methyl-1,3-diamino-2-propanol; N,N-bis(2-hydroxyethyl)glycine; tris(hydroxymethyl)methyl glycine; ammonium carbamate; citric acid; acetic acid; ammonia; alkali metal carbonates; and/or alkali metal phosphates). For additional buffers that can be used, see Mccutcheon's EMULSIFIERS AND DETERGENTS, North American Edition, 1997, Mccutcheon Division, MC Publishing Company which is incorporated herein by reference. In yet another and/or alternative embodiment, solubilizing materials, when used, can include, but are not limited to, hydrotropes (e.g., water soluble salts of low molecular weight organic acids such as the sodium and/or potassium salts of xylene sulfonic acid). In another and/or alternative embodiment, the acids, when used, include, but are not limited to, organic hydroxy acids, citric acids, keto acid, and the like.

In still another and/or alternative embodiment, thickeners, when used, include, but are not limited to, polyacrylic acid, xanthan gum, calcium carbonate, aluminum oxide, alginates, guar gum, methyl, ethyl, clays, and/or propylhydroxycelluloses. In yet another and/or alternative embodiment, defoamers, when used, include, but are not limited to, silicones, aminosilicones, silicone blends, and/or silicone/hydrocarbon blends. In still a further and/or alternative embodiment, preservatives, when used, include, but are not limited to, mildewstats or bacteriostats, methyl, ethyl and propyl parabens, short chain organic acids (e.g., acetic, lactic and/or glycolic acids), bisguanidine compounds (e.g., Dantagard and/or Glydant) and/or short chain alcohols (e.g., ethanol and/or IPA). In one aspect of this embodiment, the mildewstats or bacteriostats include, but are not limited to, mildewstats (including non-isothiazolone compounds) include Kathon GC, a 5-chloro-2-methyl-4-isothiazolin-3-one, Kathon ICP, a 2-methyl-4-isothiazolin-3-one, and a blend thereof, and Kathon 886, a 5-chloro-2-methyl-4-isothiazolin-3-one, all available from Rohm and Haas Company; Bronopol, a 2-bromo-2-nitropropane-1,3-diol, from Boots Company Ltd.; Proxel CRL, a propyl-p-hydroxybenzoate, from ICI PLC; Nipasol M, an o-phenyl-phenol, Na+ salt, from Nipa Laboratories Ltd.; Dowicide A, a 1,2-Benzoisothiazolin-3-one, from Dow Chemical Co.; and Irgasan DP 200, a 2,4,4′-trichloro-2-hydroxydiphenylether, from Ciba-Geigy A.G.

### E. Other Characteristics

In an embodiment, the composition may have a relatively low viscosity, e.g., less than 1000 cps, less than 500 cps, or less than 100 cps (e.g., from about 1 cps to 100 cps).

In an embodiment, the composition may have a pH ranging from 2 to 11, or 3 to 9. The particular pH may depend on the employed antimicrobial active. For example, when using an organic acid and/or a peroxide, pH may be on the acidic side, e.g., less than 7, such as from 2 to less than 7 (e.g., 2 to 6, or 2 to 5, or 2 to 4). Use of a quat antimicrobial active may be more versatile with respect to pH, e.g., from 2 to 11, or from 3 to 9 or from 7 to 11. Use of bleach as the antimicrobial active may benefit from a pH of greater than 8, or greater than 9, such as 8 to 11, or 9 to 11.

Examples of additional possible adjuvants may be found in U.S. Pat. Nos. 6,825,158; 8,648,027; 9,006,165; 9,234,165; 9,988,594; 10,421,929 and U.S. Publication No. 2008/003906, each of which is herein incorporated by reference in its entirety.

Additional examples are disclosed in U.S. Pat. No. 5,460,833 to Andrews et al.; U.S. Pat. No. 6,221,823 to Crisanti; U.S. Pat. No. 6,346,279 to Rochon et al.; U.S. Pat. No. 6,551,980 to Wisniewski et al.; U.S. Pat. No. 6,699,825 to Rees et al.; U.S. Pat. No. 6,803,057 to Ramirez et al.; U.S. Pat. No. 6,812,196 to Rees et al.; U.S. Pat. No. 6,936,597 to Urban; U.S. Pat. No. 7,008,600 to Katsigras et al.; U.S. Pat. No. 7,070,737 to Bains et al.; U.S. Pat. No. 7,354,604 to Ramirez et al.; U.S. Pat. No. 7,598,214 to Cusack et al.; U.S. Pat. No. 7,605,096 to Tamarchio et al.; U.S. Pat. No. 7,658,953 to Bobbert; U.S. Pat. No. 7,696,143 to McCue et al.; U.S. Pat. No. 7,915,207 to Chopskie et al.; U.S. Pat. No. 8,569,220 to Gaudrealt; U.S. Pat. No. 8,575,084 to Gaudrealt; U.S. Pat. No. 10,064,409 to Hazenkamp et al.; U.S. Pat. No. 10,076,115 to Salminen et al.; U.S. Pat. No. 10,358,624 to Mitchell et al.; U.S. Publication No. 2007/0190172 to Bobbert; PCT Publication Nos. WO 99/18180 to Raso et al.; WO 99/53006 to Masotti et al.; WO 2004/067194 to Arrigoni et al.; WO 2004/104147 to Rosiello et al.; WO 2017/174959 to Convery; and EPO Publication EP 2843034 to Nedic et al., each of which is herein incorporated by reference in its entirety.

In some embodiments, it may be possible to provide a substrate, pod or other device for delivery of the dryer sanitization or disinfection composition. In an embodiment, such could be provided in “dry” form, where dosing or loading with the sanitization or disinfection composition may occur after manufacture (e.g., by the user). Pre-dosing or loading of the substrate, pod or other device holding the sanitization or disinfection composition may be preferred, e.g., as the amount and concentrations of the components in the composition, and the loading ratio of such composition relative to the substrate or loaded pod can be more carefully controlled during manufacture, than may occur where the final composition may depend on the user following provided instructions for formulation (e.g., diluting a provided concentrate or “dry” composition).

With regard to pre-moistened substrates, a selected amount of liquid may be added to the container of such substrates during manufacture such that the substrates contain the desired amount of liquid. The substrates are not necessarily loaded to their saturation point, but are typically loaded with the composition to some ratio less than full saturation. For example, many substrates are capable of holding about 8 to 14 times their weight in liquid. For various reasons, the substrates may be loaded at a loading ratio less than saturation, e.g., less than 10:1 or less than 9:1, at least 2:1, at least 3:1, or at least 4:1 such as from 3:1 to 8:1, 3:1 to 6:1 or 6:1 to 8:1.

It is important to understand and account for how the substrate materials affect the chemistry of the composition being dosed onto the substrate. For example, it can be important to avoid or minimize unwanted chemical interactions that may inadvertently deactivate the active agents within the composition. For example, incompatibility between components in the composition versus the substrate can occur, which would be undesirable, or at least must be accounted for. The composition that is released from the pre-loaded substrate can be referred to as “squozate” The term “squozate” is used as a holdover from cleaning wipes, even though the present substrates are typically not used to wipe a give surface, and the composition loaded therein is not typically squeezed from the wipe, but is simply tossed into the dryer, and run through the dryer cycle with the fabric articles to be sanitized or disinfected. When components of a composition react with or bind to a substrate, the composition that is loaded onto the substrate differs from the “squozate”. It is desirable that an effective amount of any given active agent not only be loaded into the substrate, but actually be released in the “squozate” from such substrate, during use.

The size and shape of the substrate can vary with respect to the intended application and/or end use of the same. The substrate can have a substantially rectangular shape of a size that allows it to readily be added to a dryer. In another embodiment, another shape, e.g., circular, oval, or the like) may be provided. In an embodiment, the loaded substrate may simply be tossed into the dryer with the load of fabric articles to be sanitized or disinfected. In another embodiment, such a substrate may be attached over another structure (e.g., stretched thereover), and then added to the dryer, or stretched over a vent inlet that delivers heated air to the dryer, etc. In an embodiment, the substrate may comprise a “pod” or other device that holds and meters or otherwise dispenses the composition throughout the dryer cycle. It will be apparent that a wide variety of mechanisms are possible for delivery of such a composition to the dryer, during the dryer cycle.

The substrates may be provided pre-moistened with a disinfecting or sanitizing composition. The wet substrates can be maintained over time in a sealable container such as, for example, within a bucket or tub with an attachable lid, sealable bags, plastic pouches (e.g., “flex packs”), canisters (e.g., with a roll of substrates positioned as a “donut” in the canister), jars, and so forth. Desirably the wet, stacked substrates are maintained in a resealable container. The use of a resealable container is particularly desirable when using aqueous volatile liquid compositions since substantial amounts of water or other liquid can evaporate while using the first sheets thereby leaving the remaining sheets with little or no liquid. Exemplary resealable containers and dispensers include, but are not limited to, those described in U.S. Pat. No. 4,171,047 to Doyle et al., U.S. Pat. No. 4,353,480 to McFadyen, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference.

Typically, the disinfecting or sanitizing substrates are stacked or otherwise placed in the container and the liquid subsequently added thereto, all during mass manufacturing. No matter the packaging and dosing process, once manufactured and packaged, the substrate can subsequently be used by removing a number of desired substrates, and adding them to the dryer, with the load of fabric articles to be sanitized or disinfected. In an embodiment, 1, or more than 1 such sheet or other substrate may be added to the load (e.g., from 1 to 5 sheets or other substrates) to provide the desired level of sanitization or disinfection.

In an embodiment, each sheet or other substrate may be dosed with 10-100 g, or 20-100 g of sanitization or disinfection composition.

The dryer may be run through a drying cycle at a given elevated temperature, such as at least 110° F., at least 115° F., less than 140° F., no more than 135° F., no more than 130° F., or no more than 125° F. (e.g., 120° F.), for a given period of time. Such period of time may be at least 10 minutes, up to 60 minutes, such as 20 minutes to 40 minutes, about 15 minutes, about 20 minutes, or about 30 minutes.

Substrates, or a pod could be provided in a kit form, wherein a plurality of substrates or pods and either an associated tool (e.g., to hold the substrate in a given position relative to dryer heated air) and/or a composition for loading into such pods or substrates are provided in a single package.

In one embodiment, a provided substrate (akin to a dryer sheet) may be from about 51/2 inches to about 11 inches in length, and from about 51/2 inches to about 11 inches in width. The substrate can have dimensions such that the length and width differ by no more than about 2 inches. Larger substrates are also possible. Such larger substrates may have a length from about 51/2 inches to about 13 inches and a width from about 10 inches to about 13 inches. The substrates may be sufficiently thin to have a basis weight of no more than 200 gsm, no more than 150 gsm, no more than 100 gsm, such as from 5 to 80 gsm, or from 10 to 60 gsm. In another embodiment, the substrates may be thicker, e.g., similar to the weight characteristics of a CLOROX TOILET WAND (Substrate #1) or a CLOROX DISPOSABLE MOP CLOTH (Substrate #2).

### IV. Examples

Examples were carried out based on ASTM E2406 and/or ASTM E2274 with modifications to evaluate sanitizing efficacy of a laundry additive using actual in-use laundry dryers. Fabric carriers were inoculated with a suspension of the test organism and dried. The inoculated fabric carriers were exposed to the test substance via in-use dryer operation. Following exposure, the test carriers were assayed for survivors and dryers were sampled for cross contamination between dryer loads. Culture purity, sterility, numbers, initial suspension, and neutralization confirmation controls were preformed. Protocols specified in ASTM E2406 and ASTM E2274 reflect the general methods used, with modifications for use in residential use dryers.

Various exemplary compositions and methods of treatment were tested for their relative efficacy against a variety of target microbes, on various fabric substrates. FIG. 1 shows antimicrobial efficacy results for a composition including 0.184% of a quaternary amine, for a 5 minute treatment time, at a dryer temperature of 120° F., using a Clorox Disposable Mop Cloth (substrate #2) as the dosed substrate. The substrate was dosed at a loading ratio of 3:1, and introduced into the dryer with 3 lbs of fabric articles to be sanitized, for 5 minutes at 120° F. As shown in FIG. 1, both cotton and polyester fabric articles contaminated with Klebsiella aerogenes or Staphylococcus epidermidis were tested. As shown in FIG. 1, a somewhat greater log reduction is provided for such a composition and substrate against Staphylococcus epidermidis, although there is also a significant log reduction (although only a log reduction of about 1) against Klebsiella aerogenes.

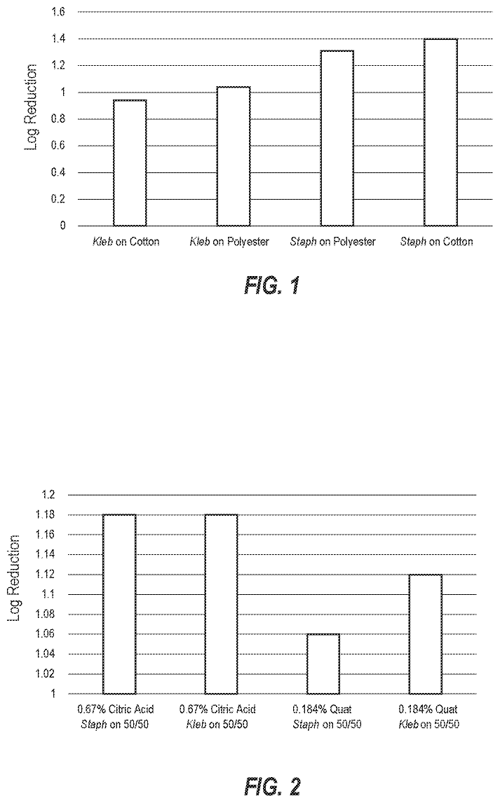

FIG. 2 shows similar testing conducted for different antimicrobial active agents (e.g., citric acid). As shown similar results of only about 1 log reduction were achieved. The test parameters were similar to those in FIG. 1, with a 3 lb load of fabric articles, at 120° F., for a treatment time of 5 min. The loading ratio was similarly 3:1, although a different substrate (Clorox Toilet Wand—substrate #1) was used on which the composition was loaded.

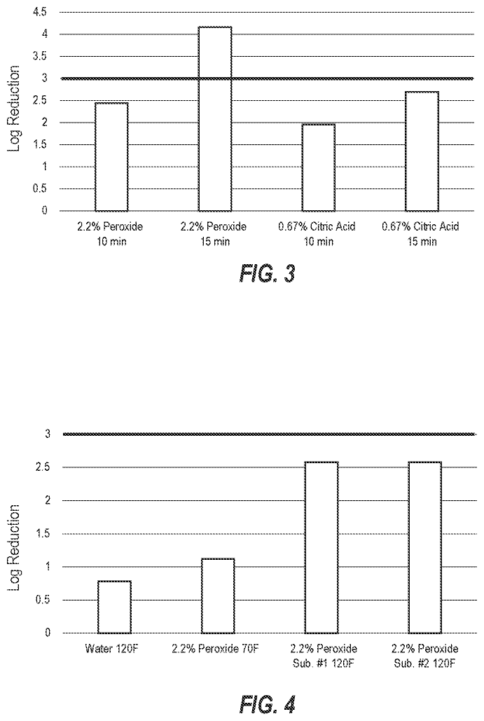

FIG. 3 shows results similar to those of FIGS. 1-2, but including results for compositions that include peroxide as the antimicrobial active agent. It is readily apparent that the peroxide results are superior to those of citric acid, or quat. Thus, in an embodiment, the present compositions include peroxide as the antimicrobial agent, rather than citric acid or quat. In an embodiment, the compositions may be free or substantially free of such alternative antimicrobial active agents.

FIG. 4 shows additional results, illustrating the role of different substrates, and treatment temperatures, as well as a comparative control, for water used alone. As shown, the results in FIG. 4 show that increased temperature provides improved results, as compared to the same peroxide composition at ambient temperature (e.g., 70° F.) treatment. The results of FIG. 4 further show that similar log reduction results can be achieved with a variety of substrates (e.g., both substrate #1 and substrate #2). The testing conducted in FIG. 4 was for a 15 minute treatment time, against Staphylococcus epidermidis, on 3 lbs of fabric articles that were a 50/50 blend of cotton/polyester. Loading ratio of the composition onto the substrates was at 3:1.

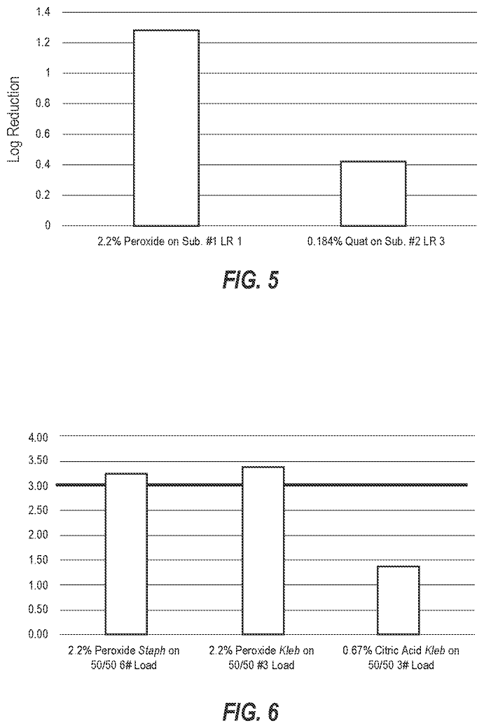

The results in FIG. 5 illustrate the effect of various loading ratios, for peroxide and quat antimicrobial active agents. As shown in FIG. 5, when reducing the loading ratio of the same peroxide composition used in FIG. 4 (2.2% peroxide) to a loading ratio of 1:1 (rather than 3:1), the log reduction was significantly reduced (e.g., to a value of about 1.25 compared to the log reduction of greater than 2.5 seen in FIG. 4). The results shown for the quat-containing composition, even at a loading ratio of 3:1, still show poor results (log reduction of only about 0.4). The testing conducted in FIG. 5 was for a 15 minute treatment time, against Staphylococcus epidermidis, on 3 lbs of fabric articles that were a 50/50 blend of cotton/polyester.

FIG. 6 explores the effect of increased load size, as well as the ability of a peroxide composition to also be effective against Klebsiella aerogenes. FIG. 6 shows results of a 2.2% peroxide composition tested on a 6 lb load against Staphylococcus epidermidis, as well as results for the same 2.2% peroxide composition tested on a 3 lb load, against Klebsiella aerogenes. A citric acid composition was also tested, on a 31b load. As with previous results, antimicrobial actives other than peroxide were shown to be inferior to the peroxide compositions. The testing conducted in FIG. 6 was for a 15 minute treatment time, at 120° F., on fabric articles that were a 50/50 blend of cotton/polyester, using substrate #1, at a loading ratio of 3:1.

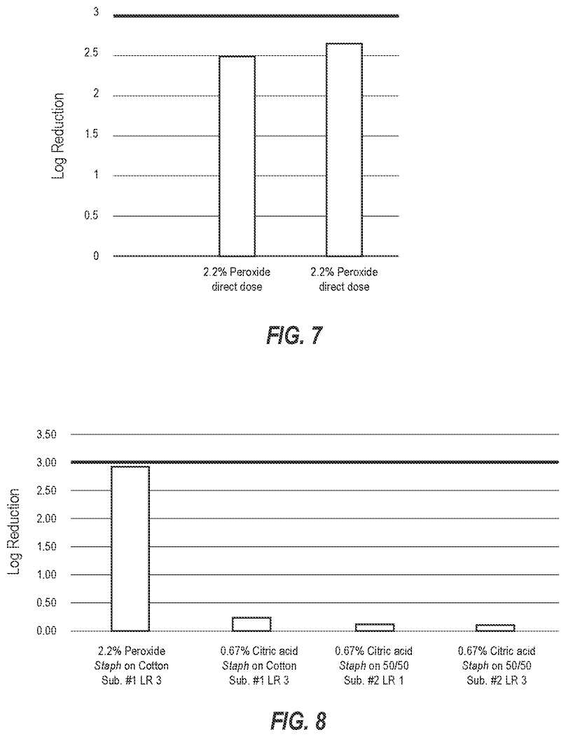

FIG. 7 tested commercially available dryer sheets for antimicrobial effect, as compared to a 2.2% peroxide composition. As shown, GAIN ORIGINAL and GRAB GREEN commercial products provide no significant log reduction against Staphylococcus epidermidis. The testing conducted in FIG. 7 was for a 15 minute treatment time, at 120° F., on 3 lbs of fabric articles that were a 50/50 blend of cotton/polyester. Rather than dosing the peroxide composition onto a substrate, in the testing of FIG. 7, 20 g of the 2.2% peroxide composition was directly sprayed onto the fabric articles being run through the 15 min dryer cycle. The commercial products tested for comparison were simply used as directed by the packaging on such products.

FIG. 8 explores efficacy of a citric acid composition against Staphylococcus epidermidis, using a variety of substrates and loading ratios, to see if there may be a combination that provides for better log reduction. As shown in FIG. 8, the tested combinations for a citric acid composition do not provide for any significant log reduction. The testing conducted in FIG. 8 was for a 15 minute treatment time, at 120° F., on 3 lbs of fabric articles (cotton or 50/50 cotton/polyester blend as noted), at loading ratios of 3:1 or 1:1, on substrates #1 and #2, as noted. FIG. 8 also shows a comparison to a 2.2% peroxide composition, under test conditions otherwise identical to the citric acid composition, where the citric acid composition achieves no better than about a 0.25 log reduction, while the 2.2% peroxide composition achieves a log reduction of nearly 3.

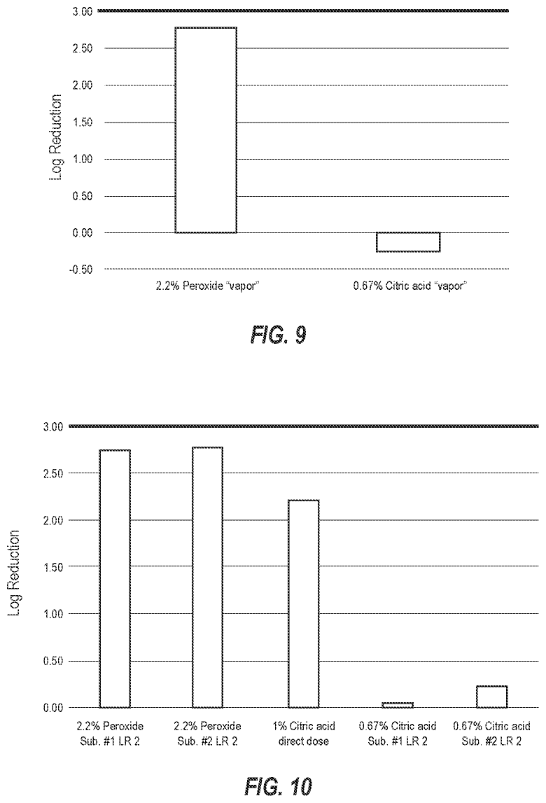

FIG. 9 illustrates results where the composition is administered without any substrate added to the dryer load, but where the dosed substrate is installed (e.g., stretched) over the hot air dryer inlet, so that the heated air passes through the dosed substrate, as it enters the drum where the fabric articles reside. The results show that such a configuration provides similar efficacy, with a 2.5-3 log reduction when using a 2.2% peroxide composition. The citric acid composition was tested using a similar method of delivery, with similar results as below—showing no significant log reduction when using a citric acid composition. The testing conducted in FIG. 9 was for a 15 minute treatment time, at 120° F., on 3 lbs of fabric articles (50/50 cotton/polyester blend), at a loading ratio of 3:1, using substrate #2. Such results show that physical contact between the dosed substrate and the fabric articles being treated is not required. As such, in an embodiment, no such physical contact is provided.

FIG. 10 shows results for higher concentrations of citric acid, as well as peroxide compositions, at different loading ratios than those shown previously. The composition including 1% citric acid, dosed directly onto the fabric articles begins to show some significant log reduction, at least against Staphylococcus epidermidis. The testing conducted in FIG. 10 was for a 15 minute treatment time, at 120° F., on 3 lbs of fabric articles (50/50 cotton/polyester blend), at a loading ratio of 2:1, using substrates #1 and #2. The 1% citric acid example was directly dosed (20 g) onto the fabric articles, without use of any substrate. Such results continue to show that peroxide provides relatively robust performance, across a variety of substrates, loading ratios, etc. The results for the directly dosed citric acid composition show that citric acid may be useful in some circumstances, at relatively high concentrations, where care is taken to carefully control the other variables.

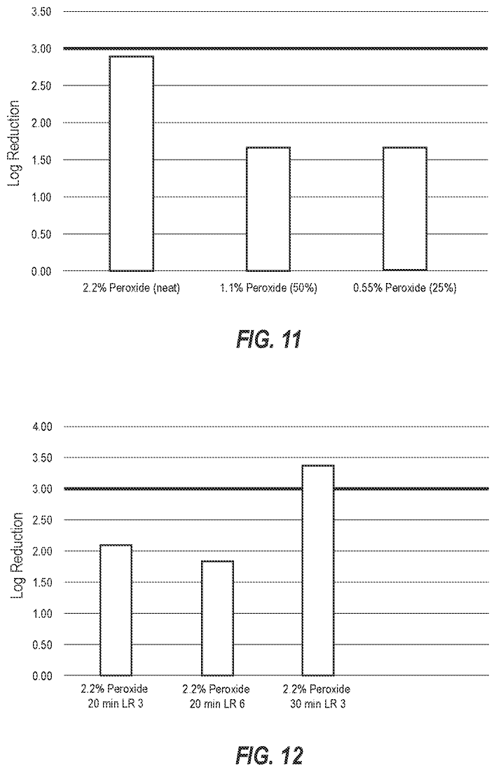

FIG. 11 explores results for where less concentration of peroxide is employed (e.g., 2.2%, 1.1%, and 0.55% peroxide compositions tested). The results show that significantly better results are achieved with the 2.2% peroxide composition as compared to 1.1% peroxide, or 0.55% peroxide. Thus in an embodiment, the composition may include at least about 2% peroxide by weight (e.g., 2-3% peroxide by weight). The lower peroxide concentrations may still provide desired results, by increasing the loading ratio or other applied dose (e.g., number of dosed wipes introduced into the dryer). The testing conducted in FIG. 11 was for a 15 minute treatment time, at 120° F., on 3 lbs of fabric articles (50/50 cotton/polyester blend), at a loading ratio of 3:1, using substrate #2.

FIG. 12 explores results for higher loading ratios of peroxide, as well as increased treatment times. The results unexpectedly show that significantly better results are achieved with an increased treatment time of 30 minutes (rather than 15 or 20 minutes), while a higher loading ratio (6:1 versus 3:1) does not appear to provide for any significant increase. Thus in an embodiment, the treatment time may be 20-40 minutes, such as about 30 minutes, and/or the loading ratio may be from 2.5 to 8, or from 3 to 6 (e.g., about 3:1, 4:1, 5:1 or 6:1). The testing conducted in FIG. 12 was conducted at 120° F., on 3 lbs of fabric articles (50/50 cotton/polyester blend), using substrate #2, for the treatment times, and at the loading ratios noted.

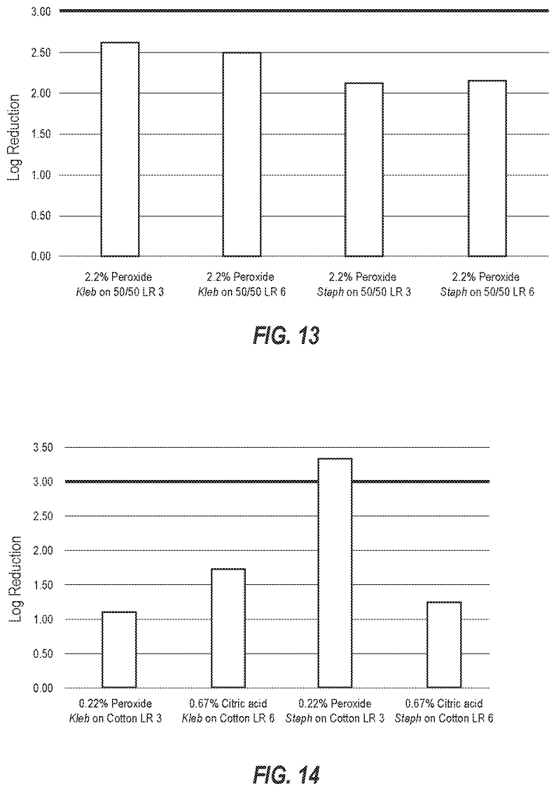

FIG. 13 explores results for different loading ratios of peroxide, against both Staphylococcus epidermidis and Klebsiella aerogenes. The results show that similar results are achieved against both Staphylococcus epidermidis and Klebsiella aerogenes with loading ratios of 3:1 or with 6:1. The testing conducted in FIG. 13 was conducted for a treatment time of 30 min, at 120° F., on 3 lbs of fabric articles (50/50 cotton/polyester blend), using substrate #2, at the loading ratios noted.

FIG. 14 shows results for different peroxide and citric acid compositions, against both Staphylococcus epidermidis and Klebsiella aerogenes. The results show that good efficacy (3 log reduction) is possible against Staphylococcus epidermidis for peroxide compositions, and significant efficacy is possible against Klebsiella aerogenes with the same peroxide composition. While citric acid shows some efficacy against Staphylococcus epidermidis and Klebsiella aerogenes, it does not reach a 3 log reduction, or even a 2 log reduction. The testing conducted in FIG. 14 was conducted for a treatment time of 30 min, at 120° F., on 3 lbs of fabric articles (cotton), using substrate #2, at the loading ratios noted. The peroxide level was adjusted to 0.22% for both peroxide runs, in order to ensure that the same number of moles of peroxide active were provided versus the other active tested (citric acid).

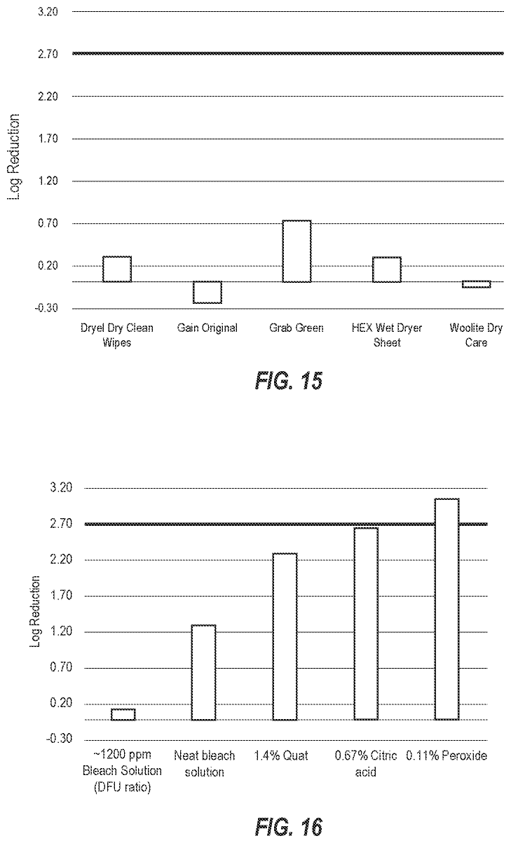

Similar to FIG. 7, FIG. 15 shows results for commercially available dryer sheets, but used in excess as compared to the proscribed instructions. As shown, the tested commercial products, even when used at 5 sheets per load, provide no significant log reduction against Staphylococcus epidermidis. The testing conducted in FIG. 15 was for a 30 minute treatment time, at 120° F., on 3 lbs of fabric articles (cotton).

FIG. 16 shows results for various peroxide, citric acid, quat, and bleach compositions, against Staphylococcus epidermidis. The results show that that excellent efficacy (3 log reduction) is possible against Staphylococcus epidermidis for peroxide compositions, with less efficacy provided by the citric acid and quat-based compositions.

The concentration of quat in the quat-based composition is significantly higher than typically employed in quat-based antimicrobial compositions, and even then, the results are still inferior to the peroxide-based composition and the citric acid-based composition. The bleach-based composition provides minimal antimicrobial efficacy. Variability relative to similar earlier conducted tests (e.g., with citric acid-based compositions) may be due to differences in the control carrier count (Staphylococcus epidermidis population size in the control). The testing conducted in FIG. 16 was conducted for a treatment time of 30 min, at 120° F., on 3 lbs of fabric articles (cotton), using substrate #2, at a loading ratio of 6:1. The peroxide level was adjusted to 0.11% for the peroxide example, in order to ensure that the same number of moles of peroxide active were provided versus the other actives tested.

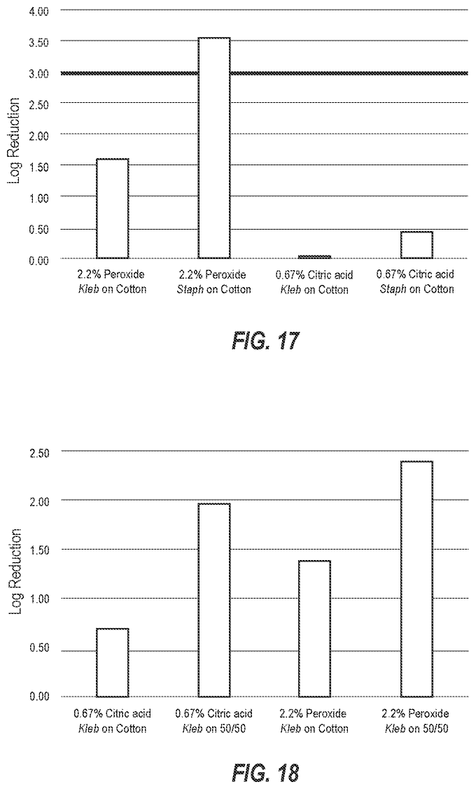

FIG. 17 shows results for peroxide and citric-acid-based compositions, against Staphylococcus epidermidis and Klebsiella aerogenes when the ballast (3 lb fabric articles) is wet, rather than dry (e.g. having just been run through a washing machine cycle). As shown, the peroxide-based composition achieves excellent results, even with a wet ballast, particularly against Staphylococcus epidermidis. The citric acid-based composition did not perform well against either Staphylococcus epidermidis and Klebsiella aerogenes, when using a wet ballast. The testing conducted in FIG. 17 was conducted for a treatment time of 30 min, at 120° F., on 3 lbs of wet fabric articles (cotton), using substrate #2, at a loading ratio of 6:1. For the previously described examples and those described hereafter, unless otherwise specified, the ballast of fabric articles was run through the dryer cycle in an already dry condition.

FIG. 18 shows results for peroxide and citric-acid-based compositions, against Klebsiella aerogenes for both cotton and cotton/polyester blend fabric materials. It will be appreciated that the fabric articles may include cotton/polyester blend fabrics, cotton fabrics, or polyester fabrics, or other fabric materials. The testing conducted in FIG. 18 was conducted for a treatment time of 30 min, at 120° F., on 3 lbs of fabric articles, using substrate #2, at a loading ratio of 3:1.

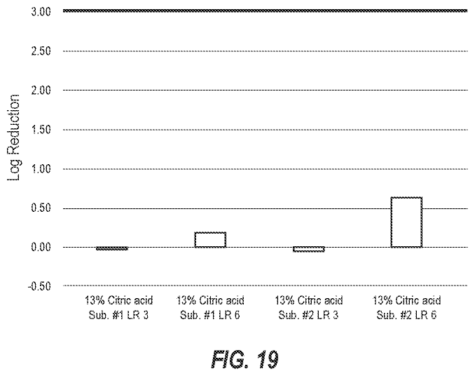

FIG. 19 shows results for a highly concentrated citric acid-based composition against Klebsiella aerogenes. The results show that even at very high citric acid concentration (13.4%), only relatively moderate log reductions were achieved. The testing conducted in FIG. 19 was conducted for a treatment time of 30 min, at 120° F., on 3 lbs of fabric articles, using a substrates #1 or #2 (as noted), at a loading ratios of 3:1 and 6:1 (as noted).

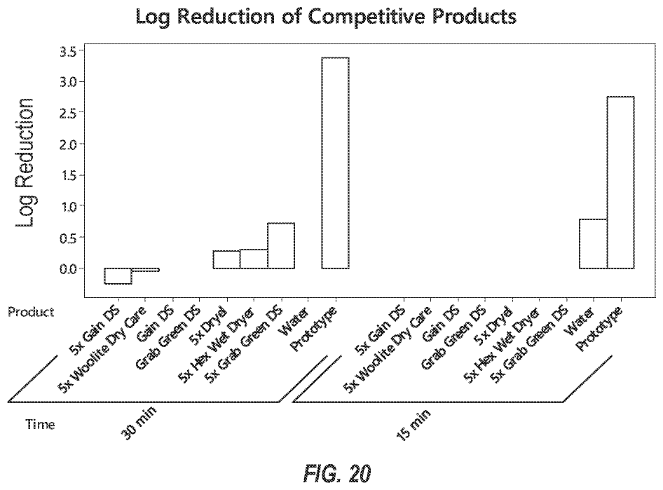

FIG. 20 summarizes results for the exemplary peroxide-based composition including 2.2% peroxide as compared to various commercially available dryer sheet products, and as compared to use of water alone. The results show that significant log reduction (e.g., 2-3 log reduction) is possible with the contemplated compositions and methods of treatment. The testing conducted in FIG. 20 was conducted for treatment times of 15 min and 30 min (as noted), at 120° F., on 3 lbs of fabric articles. The tested prototypes were loaded at a loading ratio of 3:1 on substrate #2. As shown, the commercially available dryer sheet products were tested at 5× (5 dryer sheets). The carrier fabric was a 50/50 cotton poly blend. The 15 minute tests were run against Klebsiella aerogenes, while the 30 minute tests were run against Staphylococcus epidermidis.

FIG. 21 provides a summary of results for citric acid and peroxide-based treatments. The testing conducted in FIG. 21 was conducted against Staphylococcus epidermidis for treatment times of 15 min, at 120° F., on 3 lbs of fabric articles (50/50 cotton/poly blend), at a loading ratio of 3:1 using substrate #1.

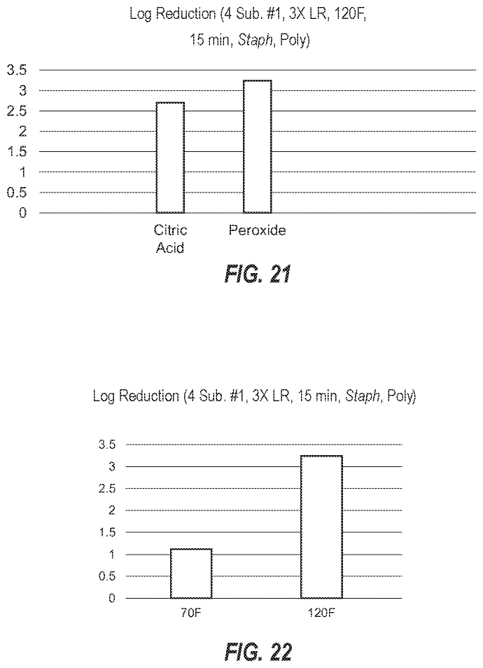

FIG. 22 provides a summary of results for peroxide-based treatments at 70° F. and 120° F. treatment temperatures. The testing conducted in FIG. 22 was conducted against Staphylococcus epidermidis for treatment times of 15 min, at 70° F. or 120° F., on 3 lbs of fabric articles (50/50 cotton/poly blend), at a loading ratio of 3:1 using substrate #1.

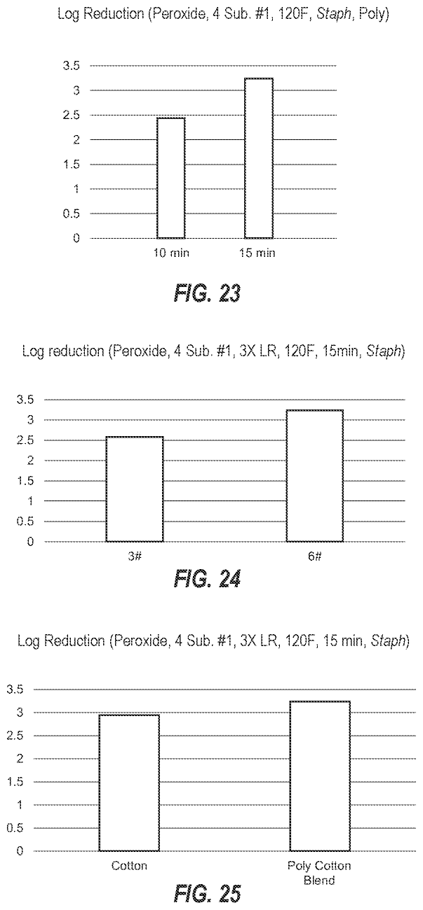

FIG. 23 provides a summary of results for peroxide-based treatments at 10 minute and 15 minute treatment times. The testing conducted in FIG. 23 was conducted against Staphylococcus epidermidis for treatment times of 10 min and 15 min, at 120° F., on 3 lbs of fabric articles (50/50 cotton/poly blend), at a loading ratio of 3:1 using substrate #1.

FIG. 24 provides a summary of results for peroxide-based treatments for 3 lb and 6 lb loads. The testing conducted in FIG. 24 was conducted against Staphylococcus epidermidis for a treatment time of 15 min, at 120° F., at a loading ratio of 3:1 using substrate #1.

FIG. 25 provides a summary of results for peroxide-based treatments for both cotton and cotton/polyester blend fabric materials. The testing conducted in FIG. 25 was conducted against Staphylococcus epidermidis for a treatment time of 15 min, at 120° F., at a loading ratio of 3:1 using substrate #1.

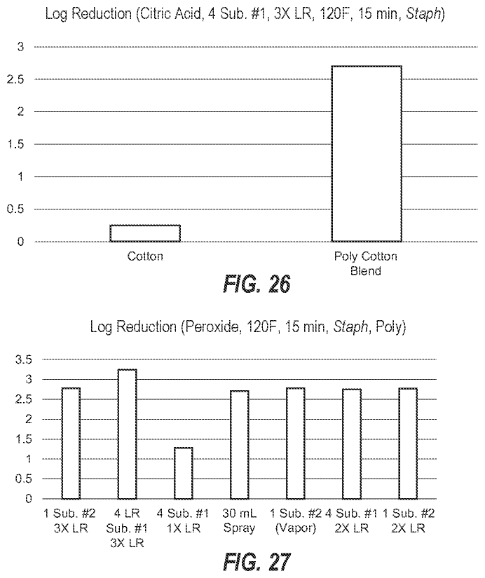

FIG. 26 provides a summary of results for a citric acid-based treatment for both cotton and cotton/polyester blend fabric materials. The testing conducted in FIG. 26 was conducted against Staphylococcus epidermidis for a treatment time of 15 min, at 120° F., at a loading ratio of 3:1 using substrate #1.

FIG. 27 provides a summary of results for a peroxide-based treatments, delivered through various mechanisms. The testing conducted in FIG. 27 was conducted against Staphylococcus epidermidis for a treatment time of 15 min, at 120° F., at the noted loading ratios and substrates or delivery mechanisms. From left to right, examples 1, 2, 4 and 5 each included 24 g of peroxide-based composition released. Examples 6 and 6 each included 16 g of peroxide-based composition released, and example 3 only included 8 g of peroxide-based composition released.

Without departing from the spirit and scope of this invention, one of ordinary skill can make various modifications to the invention to adapt it to various usages and conditions. As such, these changes and modifications are properly, equitably, and intended to be, within the full range of equivalence of the following claims.

1. A method for providing sanitization or disinfection within a dryer, the method comprising:
(a) providing a dryer sanitization or disinfection composition comprising 0.05% to 5% by weight of an antimicrobial active; and
(b) placing the dryer sanitization or disinfection composition into a fabric article drying appliance with one or more fabric articles in order to sanitize or disinfect such fabric articles;
wherein the sanitizing or disinfecting composition provides at least about a 2-log reduction against at least one gram negative or gram positive bacterial population within 30 minutes when added to the fabric article drying appliance.

2. The method of claim 1, wherein the fabric article drying appliance provides heat to the one or more fabric articles and the dryer sanitization or disinfection composition, the fabric article drying appliance being at a temperature of from 110° F. to 130° F. for at least 30 minutes.

3. The method of claim 1, wherein the fabric article drying appliance provides heat to the one or more fabric articles and the dryer sanitization or disinfection composition, the fabric article drying appliance being at a temperature of about 120° F. for at least 30 minutes.

4. The method of claim 1, wherein the sanitizing or disinfecting composition provides at least about a 3-log reduction against at least one gram negative or gram positive bacterial population within about 15 to 30 minutes.

5. The method of claim 1, wherein the antimicrobial active comprises at least one of a peroxide, a quat, an inorganic acid, or a hypohalite.

6. The method of claim 1, wherein the antimicrobial active comprises hydrogen peroxide.

7. The method of claim 1, wherein the antimicrobial active is present in an amount of from 1% to 3% by weight.

8. The method of claim 1, wherein the composition is a liquid composition.

9. The method of claim 1, wherein the composition is dosed onto a wipe or other substrate during manufacture.

10. The method of claim 1, wherein the sanitizing or disinfecting composition provides at least about a 3-log reduction against at least one gram negative or gram positive bacterial population.

11. A method for providing sanitization or disinfection within a dryer, the method comprising:
(a) providing a dryer sanitization or disinfection composition comprising 0.05% to 5% by weight of a peroxide antimicrobial active dosed onto a wipe or other substrate; and
(b) placing the wipe or other substrate dosed with the dryer sanitization or disinfection composition into a fabric article drying appliance with one or more fabric articles in order to sanitize or disinfect such fabric articles;
wherein the sanitizing or disinfecting composition provides at least about a 2-log 2 leg reduction against at least one gram negative or gram positive bacterial population on the one or more fabric articles when run within the fabric article drying appliance for 30 minutes at a temperature of about 120° F.

12. The method of claim 11, wherein the peroxide antimicrobial active comprises hydrogen peroxide.

13. The method of claim 11, wherein the antimicrobial active is present in an amount of from 1% to 3% by weight.

14. The method of claim 11, wherein the sanitizing or disinfecting composition provides at least about a 3-log reduction against at least one gram negative or gram positive bacterial population.

15. A sanitizing or disinfecting laundry treatment system for use in providing sanitization or disinfection within a dryer, the system comprising:
a sanitization or disinfection composition comprising:
(a) 0.05% to 5% by weight of an antimicrobial active; and
(b) wherein the sanitizing or disinfecting composition provides at least about a 2-log reduction against at least one gram negative or gram positive bacterial population within 30 minutes when added to a fabric article drying appliance;
a substrate or other device for holding and dispensing the sanitization or disinfection composition within the fabric article drying appliance.

16. The system of claim 15, wherein the antimicrobial active comprises at least one of a peroxide, a quat, an inorganic acid, or a hypohalite.

17. The system of claim 15, wherein the antimicrobial active comprises hydrogen peroxide.

18. The system of claim 15, wherein the antimicrobial active is present in an amount of from 1% to 3% by weight.

19. The system of claim 15, wherein the composition is dosed onto a wipe or other substrate during manufacture.

20. The system of claim 15, wherein the composition is loaded into a pod for holding and dispensing the sanitization or disinfection composition during a drying cycle of the fabric article drying appliance.
